(19) United States
(12) Patent Application Publication
(10) Pub. No.: US 2008/0151075 A1
(43) Pub. Date: Jun. 26, 2008

(54) IMAGE FORMING APPARATUS AND METHOD OF CONTROLLING CONTINUOUSLY SHOT IMAGES

(75) Inventor: Sang Hyun PARK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/957,661

(22) Filed: Dec. 17, 2007

(30) Foreign Application Priority Data
Dec. 22, 2006 (KR) 2006-132877

(51) Int. Cl. H04N 5/76; H04N 5/225

(52) U.S. Cl. 348/231.99; 348/207.99; 348/E05.024

(57) ABSTRACT

An image forming apparatus and a method of controlling the same. Since the image forming apparatus supports a search function to automatically search to find continuously shot images in images shot by a digital camera based on a shooting time, it is possible to reduce problems which arise when a user individually selects or searches to find continuously shot images. Since the image forming apparatus supports a synthesizing function to automatically synthesize the continuously shot images which are searched automatically, it is possible to synthesize the continuously shot images so as to overlap each other in shooting order according to the shooting time. Thus, it is possible to provide a variety of services to the user. Since the image forming apparatus supports an editing function to edit the synthesized image, it is possible to edit the continuously shot images without using an image editing program of a computer connected to the image forming apparatus.

### CROSS-REFERENCE TO RELATED APPLICATION

This application claims priority under 35 U.S.C § 119(a) from Korean Patent Application No. 2006-132877, filed on Dec. 22, 2006 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus capable of easily printing continuously shot images, and a method of controlling the continuously shot images.

2. Description of the Related Art

An image shot by a conventional digital camera is stored in a storage medium of the digital camera or a storage medium, such as a memory card, inserted thereinto. A user can select and print an image stored in the storage medium.

Recent digital cameras support a variety of additional shooting functions such that more shooting environments are provided to the user, in addition to basic shooting functions. Among the additional shooting functions, a continuous shooting function is a function for continuously shooting several images when pressing a shutter key once. When the continuous shooting function is used, an object which moves fast can be continuously shot.

Since the conventional digital camera supports the continuous shooting function in addition to the basic shooting functions, images which are shot by the continuous shooting function as well as images which are shot by the basic shooting functions are stored in the storage medium of the digital camera or the storage medium such as the memory card.

Meanwhile, a conventional image forming apparatus does not support a search function for automatically searching for continuously shot images, a synthesizing function for automatically synthesizing and displaying the continuously shot images, and an editing function for editing the synthesized image. Accordingly, when the user wants to print only the continuously shot images, the continuously shot images are individually searched for in the images stored in the storage medium, are manually synthesized in shooting order, and are subsequently printed. In addition, in order to edit the synthesized image, an image editing program provided in a computer should be used.

Accordingly, an operation for printing the continuously shot images is more troublesome and time-consuming.

### SUMMARY OF THE INVENTION

The present general inventive concept provides an image forming printing apparatus capable of more easily printing continuously shot images, and a method of controlling the continuously shot images.

Additional aspects and/or utilities of the general inventive concept will be set forth in part in the description which follows and, in part, will be obvious from the description, or may be learned by practice of the general inventive concept.

The foregoing and/or other aspects and utilities of the present general inventive concept are achieved by providing a method of controlling continuously shot images, the method including reading a plurality of images, acquiring shooting times of the plurality of read images, determining whether the plurality of images are continuously shot using the acquired shooting times of the images, and displaying the plurality of images, which are continuously shot, as a single image according to the determined result.

The method may further include storing the plurality of images, which are continuously shot, as the single image.

The plurality of images, which are stored as the single image, may have respective IDs.

The single image may be obtained by synthesizing the plurality of images which are continuously shot.

The determining may use a time difference between the acquired shooting times of the plurality of images.

The method may further include editing the displayed single image.

The edited single image may be re-displayed.

The method may further include outputting the displayed single image.

The shooting times may be acquired from Exchangeable image file format (Exif) information.

The foregoing and/or other aspects and utilities of the present general inventive concept are achieved by providing an image forming apparatus including an image reading unit to read a plurality of shot images, and a control unit to acquire shooting times of the plurality of read images, determine whether the plurality of images are continuously shot, and store the plurality of images, which are continuously shot, in a continuously-shot-image group if it is determined that the plurality of images are continuously shot.

The control unit may calculate a time difference between the shooting times of a predetermined image and a subsequent image among the plurality of images, determine that the predetermined image and the subsequent image are continuously shot images if the calculated time difference is smaller than or equal to a reference continuous shooting time, and determine that the predetermined image and the subsequent image are not the continuously shot images if the calculated time difference is larger than the reference continuous shooting time.

The image forming apparatus may further include a storage unit to store the plurality of images in the continuously-shot-image group, and a display unit to display the plurality of images stored in the storage unit, and the control unit may read the plurality of images stored in the continuously-shot-image group, convert the plurality of images into a suitable display format, store the plurality of converted images in the storage unit, synthesize the plurality of converted images, and display the plurality of synthesized images on the display unit.

The control unit may assign different identifications (IDs) to the plurality of converted images and display the assigned IDs of the images together when the plurality of synthesized images are displayed on the display unit.

The image forming apparatus may further include an input unit to allow a user to input a command to edit the plurality of displayed images, and the control unit receives the ID of an image, which is desired to be edited, of the displayed IDs and the editing command through the input unit, edits the image corresponding to the received ID according to the editing command, and re-synthesizes the plurality of images.

The foregoing and/or other aspects and utilities of the present general inventive concept are achieved by providing an image forming apparatus, including a reading unit to read image information of a plurality of images, and a control unit to compare differences between each of the read image information to a predetermined threshold and to store the plurality of images when the differences are each less than the predetermined threshold.

The stored images may be continuously shot images.

The image forming apparatus may further include a key input unit to receive a command to control the control unit to edit at least one of the plurality of images.

The editing command may include at least one of deleting or adjusting transparency of at least one of the plurality of images.

The control unit may edit at least one of the plurality of images corresponding to identification information input through the key input unit according to an editing command.

The image forming apparatus may further include a display unit to display at least one of the plurality of images corresponding to an input through the key input unit.

### BRIEF DESCRIPTION OF THE DRAWINGS

These and/or other aspects and utilities of the general inventive concept will become apparent and more readily appreciated from the following description of the embodiments, taken in conjunction with the accompanying drawings of which:

FIG. 1 is a schematic block diagram illustrating an image forming apparatus according to an embodiment of the present general inventive concept;

FIG. 2 is a conceptual diagram illustrating operations of searching to find shot images and of displaying continuously shot images in the image forming apparatus illustrated in FIG. 1;

FIG. 3 is a view illustrating an example of synthesizing and displaying continuously shot images with a default option in the image forming apparatus illustrated in FIG. 1;

FIG. 4 is a view illustrating an example of decreasing transparencies of images having IDs 1, 2 and 3 such that an image having an ID 4 becomes relatively clear in FIG. 3;

FIG. 5 is a view illustrating an example of deleting the image having the ID 2 in FIG. 4;

FIG. 6 is a flowchart illustrating a function of searching to find continuously shot images, which can be supported by the image forming apparatus according to another embodiment of the present general inventive concept;

FIG. 7 is a flowchart illustrating a function to synthesize the continuously shot images, which can be supported by the image forming apparatus according to another embodiment of the present general inventive concept; and

FIG. 8 is a flowchart illustrating a function to edit the continuously shot images, which can be supported by the image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

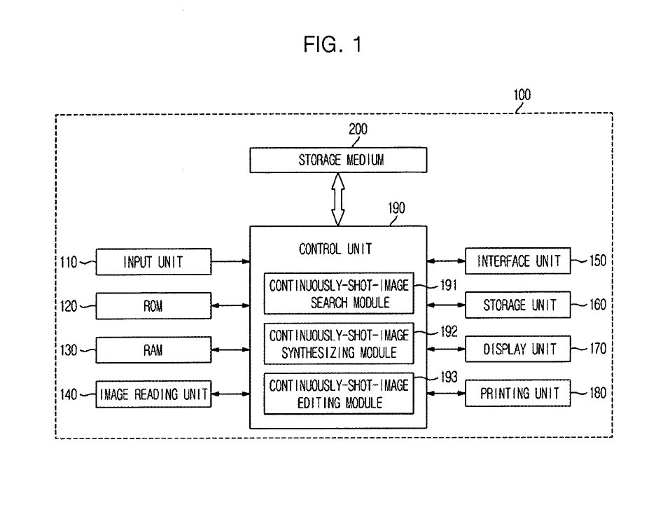

FIG. 1 is a schematic block diagram illustrating an image forming apparatus according to an embodiment of the present general inventive concept. Referring to FIG. 1, in the image forming apparatus 100 according to an embodiment of the present general inventive concept, a storage medium 200 to store a plurality of images is provided.

The image forming apparatus 100 includes an input unit 110, a read only memory (ROM) 120, a random access memory (RAM) 130, an image reading unit 140, an interface unit 150, a storage unit 160, a display unit 170, a printing unit 180, and a control unit 190.

The input unit 110 is a user interface unit. A user can set a variety of functions which can be supported by the image forming apparatus and can input a variety of commands to the image forming apparatus 100 which are necessary to operate a system. The variety of commands is transmitted to the control unit 190 through a system bus.

The ROM 120 is a non-volatile memory, which stores a program such as an operating system (OS) necessary to implement functions of the image forming apparatus.

The RAM 130 stores a variety of data generated while the control program is performed.

The image reading unit 140 reads “Exchangeable image file format” (hereinafter, referred to as Exif) information of images stored in the storage medium 200. The storage medium 200 stores images, which are shot by a digital shooting device, in a JPEG file format. The JPEG file includes the Exif information composed of shooting information and camera setting information together with a thumbnail image, scan data, and a screen nail image. The thumbnail image is a small image which is displayed on a liquid crystal display (LCD) screen in order to search the images. The screen nail image is an image which is added to the end of the JPEG file format and compressed to a size of a visible area of the LCD screen independent of the thumbnail image. In a reproduction mode, the screen nail image is restored and displayed on the LCD screen. The scan data is compression data which is generated by sampling, discrete cosine transform (DCT), quantization, and Huffman encoding processes. The Exif information includes shooting information and camera setting information such as a shooting date and time of a shot image, a shutter speed, an f-stop, a zoom magnification, resolution and existence of a flash. The Exif information is not displayed in the image and is provided as additional information when the image is viewed using an image viewer. The Exif information is recorded in a header part of an image file.

The interface unit 150 functions as an interface between the storage medium 200 and the image forming apparatus, 100 if the storage medium 200 is inserted into an external device.

The storage unit 160 stores the continuously shot images.

The display unit 170 is a user interface unit, which allows the user to check operation information of the image forming apparatus 100 implemented in the image forming apparatus 100 by characters and graphics through the display unit 170. The display unit 170 may be a cathode ray tube (CRT) or a liquid crystal display (LCD). The user can check an implementation status and result of the image forming apparatus 100 through a user interface (UI) window displayed on the display unit 170. In particular, the display unit 170 can display the images of the storage medium 200 in various forms. For instance, the display unit 170 can display continuously shot images in an order in which the images were photographed according to a shooting time such that parts thereof overlap each other.

The printing unit 180 prints print data on paper.

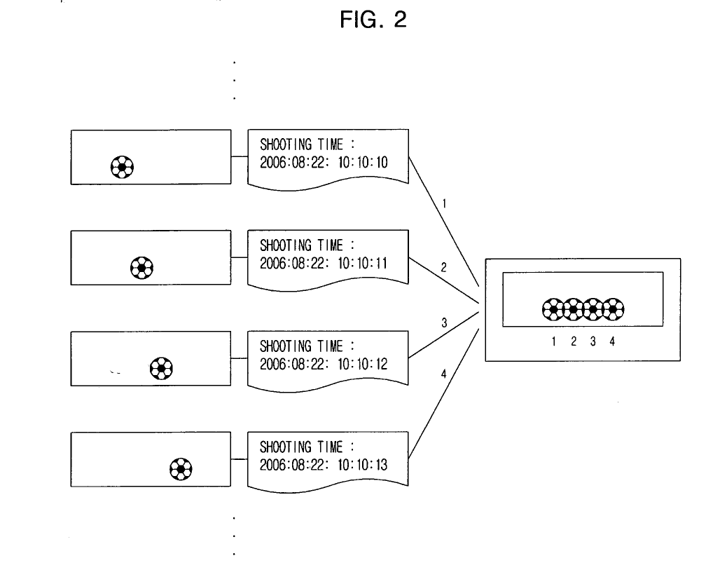

The control unit 190 controls entire printing operations of the image forming apparatus 100. The control unit 190 automatically searches to find continuously shot images in the images stored in the storage medium 200, using a continuously-shot-image search module 191. When the continuously shot images are automatically searched, the control unit 190 uses the shooting time included in the Exif information of the images read by the image reading unit 140. That is, the control unit 190 calculates a time difference between a shooting time of a first shot image and a shooting time of a subsequently shot image. When the calculated time difference is larger than a reference continuous shooting time which is previously set, it is determined that the previous image and the current image are not the continuously shot images, and, when the calculated time difference is smaller than or equal to the reference continuous shooting time, it is determined that the two images are the continuously shot images. By this method, the continuously shot images are searched for in all the images of the storage medium 200 and the searched continuously shot images are stored in a continuously-shot-image group of the storage medium 200. As illustrated in FIG. 2, for example, if the shooting times of four images (soccer balls) stored in the storage medium 200 are respectively 2006:08:22 10:10:10, 2006:08:22 10:10:11, 2006:08:22 10:10:12 and 2006:08:22 10:10:13 and the reference continuous shooting time is 3 seconds, it is determined that the four images are the continuously shot images. This is because the time difference between the shooting times of neighboring images is 1 second which is smaller than reference continuous shooting time of 3 seconds.

The control unit 190 synthesizes the searched continuously shot images, using a continuously-shot-image synthesizing module 192. When the continuously shot images are synthesized, the control unit 190 reads the images stored in the continuously-shot-image group of the storage medium 200, expands or contracts the read images to a size suitable for the display unit 170 and converts the images into a suitable display format. Identifications (IDs) are respectively assigned to the converted images, which are then stored in the storage unit 160 of the image forming apparatus 100. In addition, the control unit 190 synthesizes the continuously shot images stored in the storage unit 160 and displays the synthesized image on the display unit 170. Accordingly, the IDs of the continuously shot images stored in the storage unit 160 are also displayed. As illustrated in FIG. 2, IDs 1, 2, 3 and 4 are assigned to the four continuously shot images, which are then stored in the storage unit 160. Then, the four continuously shot images are synthesized and displayed on the display unit 170 and the IDs 1, 2, 3 and 4 are also displayed.

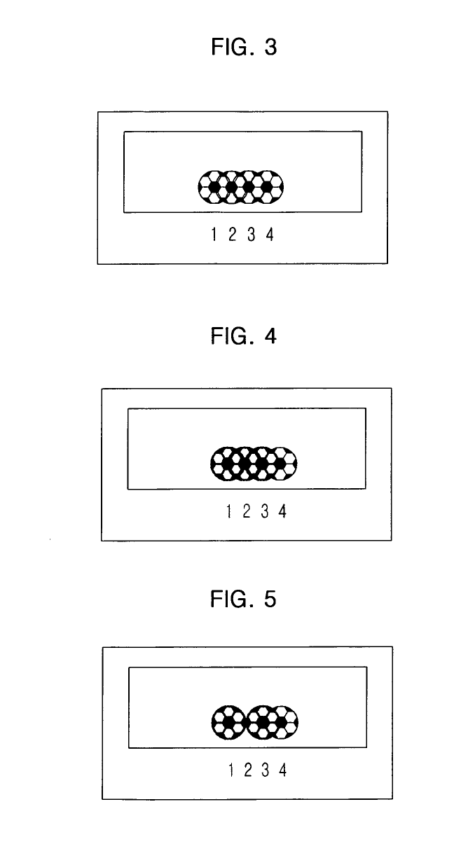

The control unit 190 edits the synthesized image according to an editing command of the user, using a continuously-shot-image editing module 193. When the continuously shot images are edited, the control unit 190 receives any one of the IDs of the displayed continuously shot images from the user and adjusts transparency of the image having the received ID or deletes the image having the received ID according to the editing command of the user. For example, when the user selects the IDs to be edited, that is, IDs 1, 2 and 3, in a state that the synthesized image is displayed with the same transparency as illustrated in FIG. 3 and decreases the transparencies of the images respectively having the IDs 1, 2 and 3, a re-synthesized image in which the image having the ID 4 becomes more clear is displayed as illustrated in FIG. 4. Accordingly, if the user deletes the unnecessary image having the ID 2 from the re-synthesized image, a re-synthesized image in which the image having the ID 2 is deleted is displayed as illustrated in FIG. 5.

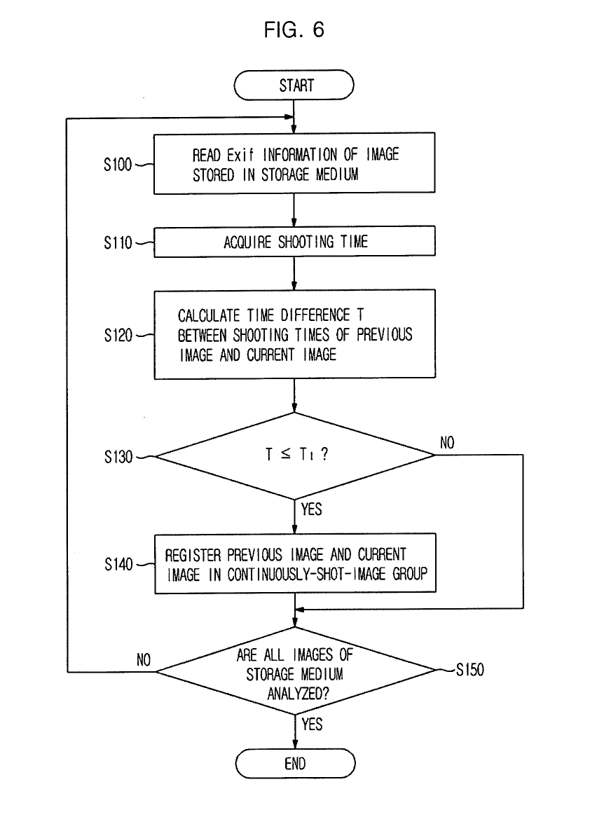

The continuously-shot-image search function of the image forming apparatus 100 having the above-described configuration will be described in detail with reference to FIG. 6. First, the image forming apparatus 100 reads the Exif information of the images stored in the storage medium 200 in operation S100, and acquires shooting times included in the Exif information in operation S110.

The image forming apparatus 100 calculates a time difference T between the shooting times of the a first shot image and a subsequently shot image (a.k.a., two continuous images) in operation S120 and determines whether the calculated time difference T is smaller than or equal to the reference continuous shooting time Tₜ which is previously set for the determination of the continuously shot images in operation S130. If it is determined that the calculated time difference T is larger than the reference continuous shooting time Tₜ, operation S150 is performed.

If it is determined that the calculated time difference T is smaller than or equal to the reference continuous shooting time Tₜ, the previous image and the current image are registered in the continuously-shot-image group in the storage medium 200 as the continuously shot images in operation S140.

In operation S150, the image forming apparatus 100 determines whether all the images stored in the storage medium 200 are analyzed. If all the images are not analyzed, operations S100 through S140 are performed again. On the other hand, if the all the images are analyzed, the continuously-shot-image search function is finished.

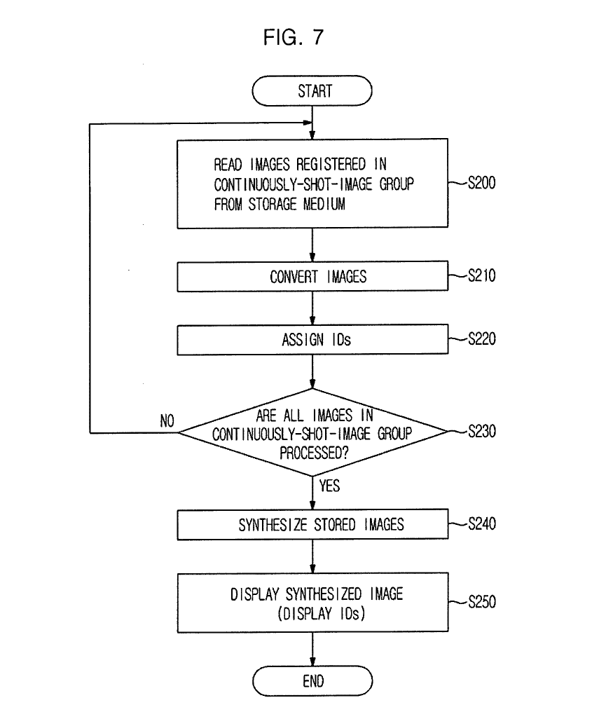

The continuously-shot-image synthesizing function of the image forming apparatus 100 having the above-described configuration will be described in detail with reference to FIG. 7. First, the image forming apparatus 100 reads the images registered in the continuously-shot-image group of the storage medium 200 in operation S200. The image forming apparatus 100 expands or reduces the read images to the size suitable for the display unit 170 and converts the images into the suitable display format in operation S210. The IDs are assigned to the converted images, which are then stored in the storage unit 160 in operation S220.

Then, the image forming apparatus 100 determines whether all the images in the continuously-shot-image group are processed in operation S230. If all the images are not processed, operation S200 is performed, and if all the images are processed, the continuously shot images stored in the storage unit 160 are synthesized with the default option in operation S240 and the synthesized image is displayed on the display unit 170 in operation S250. Accordingly, the IDs of the continuously shot images stored in the storage unit 160 are also displayed. Then, the continuously-shot-image synthesizing function is finished.

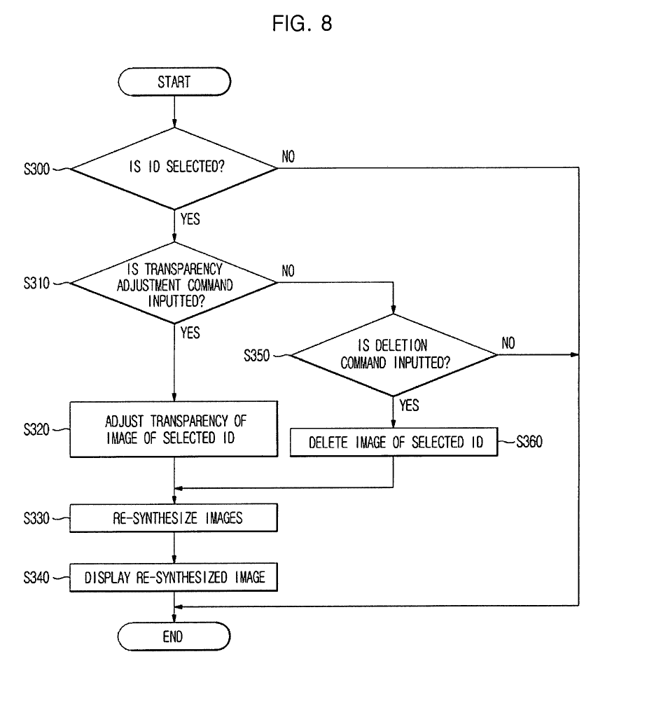

The continuously-shot-image editing function of the image forming apparatus 100 having the above-described configuration will be described in detail with reference to FIG. 8. First, the image forming apparatus 100 determines whether the user selects any one of the IDs of the images included in the synthesized image in operation S300.

If any one of the IDs is selected, it is determined whether the user inputs a transparency adjustment command of image editing commands in operation S310. If the transparency adjustment command is input, the transparency of the image of the ID selected by the user increases or decreases in operation S320.

The image having the adjusted transparency and the rest of the images are re-synthesized in operation S330 and the re-synthesized image is displayed in operation S340.

When the transparency adjustment command is not input in operation 310, it is determined whether a deletion command is input in operation S350. If the deletion command is input, the image of the ID selected by the user is deleted in operation S360 and the images, except for the image of the selected ID, are re-synthesized in operation S330 and the re-synthesized image is displayed in operation S340.

Then, the edited continuously shot images are printed according to a printing command of the user.

As described above, according to an embodiment of the present general inventive concept, since an image forming apparatus supports a search function to automatically searching to find continuously shot images in images shot by a digital shooting device, it is possible to reduce problems which arise when a user individually selects or searches to find continuously shot images.

According to another embodiment of the present general inventive concept, since the image forming apparatus supports a synthesizing function to automatically synthesizing the continuously shot images which are searched automatically, it is possible to synthesize the continuously shot images in shooting order. Thus, it is possible to provide a variety of services to the user.

According to another embodiment of the present general inventive concept, since the image forming apparatus supports an editing function to edit the synthesized image, it is possible to edit the continuously shot images without using an image editing program of a computer connected to the image forming apparatus.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A method of controlling continuously shot images, the method comprising:
reading a plurality of images;
acquiring shooting times of the plurality of read images;
determining whether the plurality of images are continuously shot using the acquired shooting times of the images; and
displaying the plurality of images, which are continuously shot, as a single image according to the determined result.

2. The method according to claim 1, further comprising storing the plurality of images, which are continuously shot, as the single image.

3. The method according to claim 2, wherein the plurality of images, which are stored as the single image, have respective IDs.

4. The method according to claim 1, wherein the single image is obtained by synthesizing the plurality of images which are continuously shot.

5. The method according to claim 1, wherein the determining uses a time difference between the acquired shooting times of the plurality of images.

6. The method according to claim 1, further comprising editing the displayed single image.

7. The method according to claim 6, wherein the edited single image can be re-displayed.

8. The method according to claim 1, further comprising outputting the displayed single image.

9. The method according to claim 1, wherein the shooting times are acquired from Exchangeable image file format (Exif) information.

10. An image forming apparatus, comprising:
an image reading unit to read a plurality of shot images; and
a control unit to acquire shooting times of the plurality of read images, determine whether the plurality of images are continuously shot, and store the plurality of images, which are continuously shot, in a continuously-shot-image group if it is determined that the plurality of images are continuously shot.

11. The image forming apparatus according to claim 10, wherein the control unit calculates a time difference between the shooting times of a predetermined image and a subsequent image among the plurality of images, determines that the predetermined image and the subsequent image are continuously shot images if the calculated time difference is smaller than or equal to a reference continuous shooting time, and determines that the predetermined image and the subsequent image are not the continuously shot images if the calculated time difference is larger than the reference continuous shooting time.

12. The image forming apparatus according to claim 10, further comprising:
a storage unit to store the plurality of images in the continuously-shot-image group; and
a display unit to display the plurality of images stored in the storage unit,
wherein the control unit reads the plurality of images stored in the continuously-shot-image group, converts the plurality of images into a suitable display format, stores the plurality of converted images in the storage unit, synthesizes the plurality of converted images, and displays the plurality of synthesized images on the display unit.

13. The image forming apparatus according to claim 12, wherein the control unit assigns different identifications (IDs) to the plurality of converted images and displays the assigned IDs of the images together when the plurality of synthesized images are displayed on the display unit.

14. The image forming apparatus according to claim 13, further comprising an input unit to allow a user to input a command to edit the plurality of displayed images,
wherein the control unit receives the ID of an image, which is desired to be edited, of the displayed IDs and the editing command through the input unit, edits the image corresponding to the received ID according to the editing command, and re-synthesizes the plurality of images.

15. An image forming apparatus, comprising:
a reading unit to read image information of a plurality of images; and
a control unit to compare differences between each of the read image information to a predetermined threshold and to store the plurality of images when the differences are each less than the predetermined threshold.

16. The image forming apparatus of claim 15, further comprising:
a key input unit to receive a command to control the control unit to edit at least one of the plurality of images.

17. The image forming apparatus of claim 16, wherein the editing command includes at least one of deleting or adjusting transparency of at least one of the plurality of images.

18. The image forming apparatus of claim 16, wherein the control unit edits at least one of the plurality of images corresponding to identification information input through the key input unit according to an editing command.

19. The image forming apparatus of claim 16, further comprising:
a display unit to display at least one of the plurality of images corresponding to an input through the key input unit.
